(19) United States
(12) Patent Application Publication
(10) Pub. No.: US 2025/0067288 A1
(43) Pub. Date: Feb. 27, 2025

(54) COUPLING FOR CONNECTING THE ENDS OF TWO ROTATABLE SHAFTS

(71) Applicant: AKTIEBOLAGET SKF, GOTEBORG (SE)

(72) Inventors: Ingemar GUSTAFSSON, Forsbacka (SE); Olof MOLIN, Sandviken (SE)

(21) Appl. No.: 18/806,880

(22) Filed: Aug. 16, 2024

(30) Foreign Application Priority Data
Aug. 25, 2023 (DE) 102023208147.4

(51) Int. Cl. F16B 2/00; F16B 7/00

(52) U.S. Cl. CPC F16B 2/005; F16B 7/00

(57) ABSTRACT

A coupling for connecting an end of a first shaft having a cross section to an end of a second shaft having the cross section includes a first sleeve having an interior opening having a shape complementary to the cross section, the interior opening being delimited by an interior surface and a friction coating on the interior surface. The friction coating includes asperities projecting from the inner surface and pores between the asperities and a sealant at least partially filling the pores between the asperities. Also a system of the coupling and the shafts and a method for connecting two shafts using the coupling.

### CROSS-REFERENCE

This application claims priority to German patent application no. 10 2023 208 147.4 filed on Aug. 25, 2024, the contents of which are fully incorporated herein by reference.

### TECHNOLOGICAL FIELD

The present disclosure is directed to a shaft connection usable in propulsion systems and drive shafts, and more precisely to the sealing of a shaft connection. The disclosure is further directed to a coupling for connecting the ends of two rotatable shafts, a propulsion system comprising such a coupling, and a method for manufacturing such a coupling.

### BACKGROUND

Propulsion systems generally include several shafts, and some of these shafts may need to be rotationally coupled. Couplings are used to connect the ends of two adjacent shafts and to transmit torque from one shaft to the other. In particular, a certain group of couplings includes a friction coating in contact with the ends of the two shafts to be connected. This friction coating increases friction considerably and provides a higher torque transmission capacity.

When a propulsion system includes a hollow shaft and also a device incorporating oil or another fluid, a sealing function is needed to prevent leakage between the shafts and the rest of the propulsion system. A well-known solution is to attach seal rings to the coupling ends. However, this solution requires additional parts, external to the coupling, which also adds complexity to the propulsion system.

### SUMMARY

Consequently, the present disclosure addresses these disadvantages by providing a simple and light-weight sealing solution between the ends of two shafts to be rotationally connected and a friction coated coupling that does not require the installation of additional components.

One aspect of the present disclosure is to provide a coupling for connecting the ends of two shafts, the coupling comprising at least one surface at least partially covered with a friction coating and configured to at least partially come into contact with at least one of the ends of the two shafts to be connected, the friction coating comprising asperities which protrude from the at least one surface and pores.

Besides, all or part of the friction coating comprises a sealant filling the pores formed between the asperities of the friction coating. The sealant prevents oil or other fluid from leaking out between the shafts and the coupling and also from leaking out from the propulsion system. The coupling includes a sealing function and no external or extra components such as sealing rings are needed.

Preferably, the size of the pores is between 0 and 0.2 mm. Preferably, the size of the asperities is between 0 and 0.1 mm. In the present description, the bounds of a value domain are included in this domain, especially in the expression “is between . . . and . . . ”. More preferably, the sealant fills the pores of the friction coating at a height ranging from the lowest asperities to the highest asperities.

In a first embodiment, the coupling may comprise an inner sleeve having an inner surface configured to come into axial contact with the ends of the two shafts to be connected and an outer sleeve mounted around the inner sleeve, where the friction coating at least partially covers the inner surface of the inner sleeve.

According to a general feature, the sealant is located on two spaced regions each positioned at one end of the inner sleeve, and the sealant covers each region in the circumferential direction.

In a second embodiment, the coupling may comprise an inner sleeve having an inner surface configured to come into axial contact with one of the ends of the two shafts to be connected and an outer sleeve mounted around the inner sleeve. The inner sleeve comprises a flange having a radial surface configured to come into radial contact with a flange of the other of the ends of the two shafts to be connected, the friction coating at least partially covering the inner surface of the inner sleeve and the radial surface of the inner sleeve.

Alternatively, the coupling may comprise an inner sleeve having an inner surface configured to come into axial contact with one of the ends of the two shafts to be connected and an outer sleeve mounted around the inner sleeve, the inner sleeve comprising a flange having a radial surface configured to come into radial contact with a flange of the other of the ends of the two shafts to be connected, the friction coating covering at least partially the inner surface of the inner sleeve.

As another alternative, the coupling may comprise an inner sleeve having an inner surface configured to come into axial contact with one of the ends of the two shafts to be connected and an outer sleeve mounted around the inner sleeve, the inner sleeve comprising a flange having a radial surface configured to come into radial contact with a flange of the other of the ends of the two shafts to be connected, the friction coating covering at least partially the radial surface of the inner sleeve.

Alternatively, the coupling may comprise an inner sleeve having an inner surface configured to come into axial contact with one of the ends of the two shafts to be connected and an outer sleeve mounted around the inner sleeve, the outer sleeve comprising a flange having a radial surface configured to come into radial contact with a flange of the other of the ends of the two shafts to be connected, the friction coating covering at least partially the inner surface of the inner sleeve and the radial surface of the outer sleeve.

As another alternative, the coupling may comprise an inner sleeve having an inner surface configured to come into axial contact with one of the ends of the two shafts to be connected and an outer sleeve mounted around the inner sleeve, the outer sleeve comprising a flange having a radial surface configured to come into radial contact with a flange of the other of the ends of the two shafts to be connected, the friction coating covering at least partially the radial surface of the outer sleeve.

As another alternative, the coupling may comprise an inner sleeve having an inner surface configured to come into axial contact with one of the ends of the two shafts to be connected and an outer sleeve mounted around the inner sleeve, the outer sleeve comprising a flange having a radial surface configured to come into radial contact with a flange of the other of the ends of the two shafts to be connected, the friction coating covering at least partially the inner surface of the inner sleeve.

Preferably, the sealant comprises at least one polymer. Advantageously, the sealant may be applied as a liquid polymer on the friction coating.

Another aspect of the disclosure is to provide a propulsion system comprising two rotatable shafts and at least one coupling as previously described, the friction coating being frictionally engaged with at least one of the ends of the two rotatable shafts.

Another aspect of the disclosure is to provide a method for manufacturing a coupling as previously described, comprising applying a sealant to all or part of the friction coating on the at least one surface of the coupling configured to come into contact with the ends of the two shafts. Advantageously, the sealant may be applied by painting, spraying or bathing.

Another aspect of the disclosure comprises a coupling for connecting an end of a first shaft having a cross section to an end of a second shaft having the cross section. The coupling comprises a first sleeve having an interior opening having a shape complementary to the cross section, the interior opening being delimited by an interior surface and a friction coating on the interior surface, the friction coating including asperities projecting from the inner surface and pores between the asperities and a sealant at least partially filling the pores between the asperities.

A further aspect of the disclosure comprises a system formed from the coupling according to claim 1, the first shaft, and the second shaft. The end of the first shaft extends into a first end of the first sleeve and is frictionally coupled to the first end of the first sleeve, and the end of the second shaft extends into a second end of the first sleeve and is frictionally coupled to the first end of the first sleeve.

Advantageously, the method for manufacturing a coupling may comprises a preliminary step of applying the friction coating on the at least one surface of the coupling by thermal spraying. Advantageously, the method for manufacturing a coupling may comprise a step of smoothing the at least one surface of the coupling configured to come into contact with the ends of the two shafts after applying the sealant.

### BRIEF DESCRIPTION OF THE DRAWINGS

Other advantages and features of the invention will appear from the detailed description of embodiments of the invention, which are non-limiting examples, illustrated on the appended drawings of which:

FIG. 1 is a sectional view through the longitudinal axis of a coupling connecting the ends of two shafts of a propulsion system according to a first embodiment of the present disclosure.

FIG. 2 is a detailed view of a friction coating on the inner surface of the coupling illustrated in FIG. 1.

FIG. 3 is a sectional view through the longitudinal axis of a coupling connecting the ends of two shafts of a propulsion system according to a second embodiment of the present disclosure.

### DETAILED DESCRIPTION

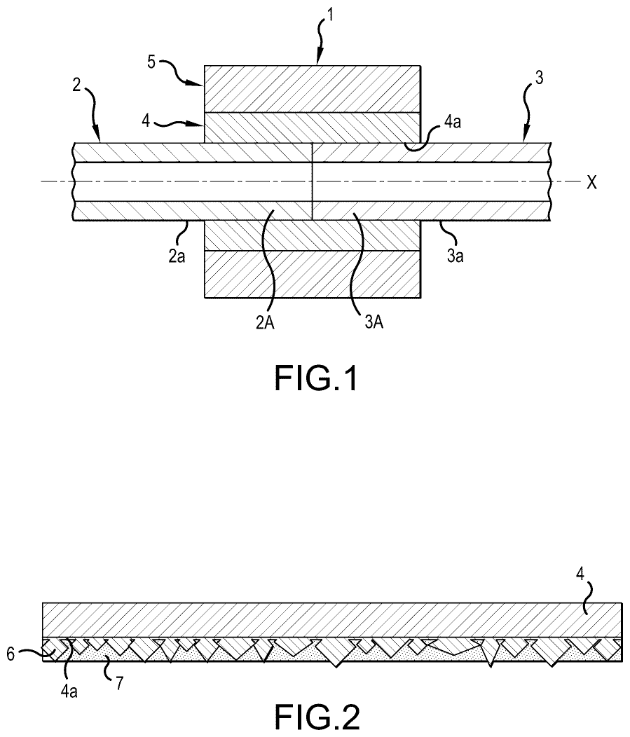

FIG. 1 illustrates the end 2A of a first rotatable shaft 2 and the end 3A of a second rotatable shafts 3 of a propulsion system and a coupling 1 mounted on the first and second shafts 2, 3 to connect them to each other according to a first embodiment of the disclosure.

The first and second shafts 2, 3 are both hollow cylindrical shafts that extend along a common axis X and have outer surfaces 2a and 3a, respectively.

The coupling 1 comprises a first sleeve 4 (an inner sleeve) and a second sleeve 5 (an outer sleeve) mounted around the first sleeve 4. An inner surface 4a of the first sleeve 4 radially contacts the outer surfaces 2a, 3a of the first and second shafts 2, 3.

The inner surface 4a of the first sleeve 4 is covered with a friction coating 6, for example, a thermal spray coating, as shown in FIG. 2 that contacts the ends 2A, 3A of the first and second shafts 2, 3 to be connected. The entire inner surface 4a of the first sleeve 4 may be covered with the friction coating 6. Alternatively, only a part of the inner surface 4a of the first sleeve 4 may be covered with the friction coating 6.

The friction coating 6 comprises asperities which extend from the inner surface 4a of the first sleeve 4, as well as pores or spaces between the asperities. The pores extend inwards from the inner surface 4a.

In addition, the friction coating 6 comprises a sealant 7. The sealant 7 fills, advantageously, the pores formed between the asperities of the friction coating 6. The sealant 7 is located on the inner surface 4a of the first sleeve 4 and thus positioned between the coupling 1 and the ends 2A, 3A of the first and second shafts 2, 3.

The sealant prevents oil or other fluid to leak out between the shafts 2, 3 and the coupling 1 and to leak out from the propulsion system. The coupling 1 now also includes a sealing function. The sealing function is included in the coupling 1 and no external or extra components such as sealing rings is needed.

Preferably, the sealant 7 fills the pores of the friction coating 6 at a height ranging from the lowest to the highest asperities in such a way as to provide a sealing function while continuing to perform its friction function. The sealant 7 may comprise at least one polymer. In the illustrated example, the sealant 7 covers the entire inner surface 4a of the first sleeve 4.

Alternatively, the sealant 7 may cover only partially the inner surface 4a of the first sleeve 4. As an example, the sealant 7 may be located on two spaced regions each positioned at one end of the first sleeve 4, the sealant 7 covering each region in the circumferential direction.

In the illustrated example, the coupling 1 comprises first and second (or inner and outer) sleeves 4, 5. Alternatively, the coupling 1 may comprise a single sleeve mounted around at least one of the first and second shafts 2, 3 and comprising the friction coating 6 and the sealant 7.

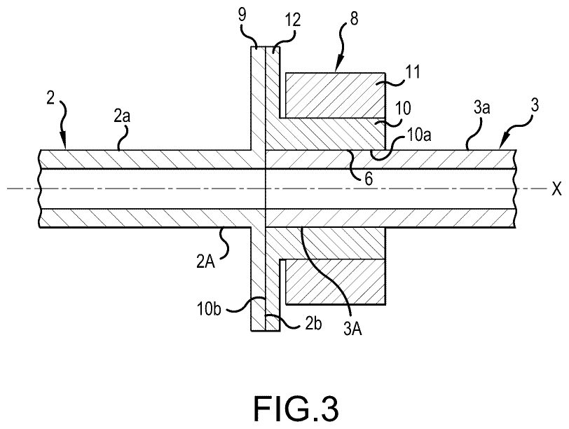

FIG. 3 illustrates the ends 2A, 3A of first and second rotatable shafts 2, 3 connected by a coupling 8 according to a second embodiment of the disclosure.

The example shown on FIG. 3, in which identical parts are given identical references, differs from the first embodiment of FIG. 1 in that the ends 2A of the first shaft 2 includes a flange 9 comprising a radial surface 2b.

The first shaft 2 can be part, for example, of a motor shaft or a gearbox.

The coupling 8 comprises a first sleeve 10 (an inner sleeve) and a second sleeve 11 (an outer sleeve) mounted around the first sleeve 10. The first sleeve 10 comprises an inner surface 10a coming into axial contact with the end 3a of the second shaft 3. At one of its ends, the first sleeve 10 also includes a flange 12 comprising a radial surface 10b coming into contact with the radial surface 2b of the first shaft 2.

Besides, the inner surface 10a and the radial surface 10b of the first sleeve 10 are covered with the friction coating 6 as previously described and shown in the detailed view of FIG. 2. The friction coating 6 comes into contact with the radial surface 2b of the first shaft 2 and the outer surface 3a of the second shafts 3.

In addition, the friction coating 6 comprises the sealant 7 as previously described, filling its pores, the sealant 7 being positioned between the coupling 8 and the ends 2A, 3A of the first and second shafts 2, 3. The friction coating 6 and the sealant 7 are located on the inner surface 10a of the first sleeve 10 and are thus positioned between the coupling 8 and the ends 2A, 3A of the first and second shafts 2, 3. In addition, the sealant 7 and optionally also the friction coating 6 are located on the radial surface 10b in contact with the flange 9.

The sealant prevents oil or other fluid from leaking out between the shafts 2, 3 and the coupling 8 and from leaking out from the propulsion system.

In the illustrated example, the coupling 8 comprises first and second (inner and outer) sleeves 10, 11. Alternatively, the coupling 8 may comprise a single sleeve mounted around at least one of the first and second shafts 2, 3 and comprising the friction coating 6 and the sealant 7.

The disclosure also concerns a method of manufacturing a coupling 1, 8 as previously described comprising applying a sealant to the friction coating 6. The sealant 7 may be applied by painting, spraying or bathing. Preferably, after applying the sealant 7 on the friction coating 6, the sealant 7 is smoothed so that the sealant 7 fills the pores of the friction coating 6 at a height ranging from the lowest to the highest asperities.

In use, the end 2a of the first shaft 2 and the end 3a of the second shaft 3 are inserted into the interior of the coupling 1 so that the friction coating 6 and the sealant 7 frictionally engage the outer surfaces of the ends 2a, 3a of the shafts 2, 3. In the alternative, the coupling 1 may be heated to enlarge the inner diameter of the coupling to allow the ends 2a, 3a of the shafts 2, 3 to be inserted into the coupling 1 with little or no frictional resistance. The friction coating is then pressed against the exterior surface of the ends 2a, 3a of the shafts 2, 3 when the coupling cools and forms a shrink fit with the shafts 2, 3.

Advantageously, the method for manufacturing a coupling may comprises a preliminary step of applying the friction coating 6 by thermal spraying. Preferably, the friction coating 6 is formed by plasma technology and may comprise carbide compounds.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved shaft couplings.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A coupling for connecting an end of a first shaft having a cross section to an end of a second shaft having the cross section, the coupling comprising:
a first sleeve having an interior opening having a shape complementary to the cross section, the interior opening being delimited by an interior surface, and
a friction coating on the interior surface, the friction coating including asperities projecting from the inner surface and pores between the asperities and a sealant at least partially filling the pores between the asperities.

2. The coupling according to claim 1,
wherein a thickness of the sealant is equal to a maximum height of the asperities.

3. The coupling according to claim 1,
including a second sleeve mounted on an outer surface of the first sleeve.

4. The coupling according to claim 3,
wherein the sealant is located on two spaced regions each positioned at one end of the first sleeve, the sealant covering each region in a circumferential direction.

5. The coupling according to claim 1
wherein the first sleeve includes a flange, and
wherein the friction coating at least partially covers a radial surface of the flange.

6. A system comprising:
the coupling according to claim 1,
the first shaft, and
the second shaft,
wherein the end of the first shaft extends into a first end of the first sleeve and is frictionally coupled to the first end of the first sleeve, and
wherein the end of the second shaft extends into a second end of the first sleeve and is frictionally coupled to the first end of the first sleeve.

7. A method of forming a coupling for connecting an end of a first shaft having a cross section to an end of a second shaft having the cross section, the comprising:
providing a sleeve having an interior opening delimited by an interior surface and having a shape complementary to the cross section, and
applying a friction coating to the interior surface, the friction coating including asperities projecting from the inner surface and pores between the asperities, and
applying a sealant to the friction coating to at least partially fill the pores between the asperities.

8. The method according to claim 7, wherein applying the sealant comprises painting, spraying or bathing.

9. The method according to claim 7,
wherein applying the friction coating comprising applying the friction coating by a thermal spraying process.

10. A method of connecting an end of a first shaft having a cross section to an end of a second shaft having the cross section comprising:
providing a coupling according to claim 1,
inserting the end of the first shaft into a first end of the first sleeve to form a friction connection between the end of the first shaft and the sleeve, and
inserting the end of the second shaft into a second end of the first sleeve to form a friction connection between the end of the second shaft and the first sleeve.
